(19) United States
(12) Patent Application Publication
(10) Pub. No.: US 2026/0220914 A1
(43) Pub. Date: Jul. 30, 2026

(54) INFORMATION PROCESSING SYSTEM, INFORMATION PROCESSING METHOD, AND NON-TRANSITORY COMPUTER READABLE MEDIUM

(71) Applicant: NEC Corporation, Tokyo (JP)

(72) Inventors: Yuka OGINO, Tokyo (JP); Takahiro TOIZUMI, Tokyo (JP); Yuho SHOJI, Tokyo (JP)

(73) Assignee: NEC Corporation, Tokyo (JP)

(21) Appl. No.: 19/145,228

(22) PCT Filed: Jan. 13, 2023
(86) PCT No.: PCT/JP2023/000745

§ 371 Date: Jul. 2, 2025

(51) Int. Cl. G06V 10/764; G06T 7/60

(52) U.S. Cl. CPC G06V 10/764; G06T 7/60

(57) ABSTRACT

An information processing system (100) comprises a feature extraction unit (112) and an estimation unit (113). The feature extraction unit (112) extracts features of an object shown in an image. The estimation unit (113) uses the extracted features to estimate a type of the object and a shape type and shape parameters corresponding to the object.

### TECHNICAL FIELD

The present disclosure relates to an information processing system, an information processing device, an information processing method, and a recording medium.

### BACKGROUND ART

Various techniques for recognizing an object included in an image have been proposed. For example, PTL 1 discloses a technique for recognizing an object that is not registered in training data. In the technique described in PTL 1, a known object recognition unit recognizes a known object registered in training data from an image. The generalization object recognition unit recognizes a generalizable generalization object by combining known objects registered in the training data.

For example, PTL 2 describes a technique for determining a rough range (object range) in which a detection object exists from an image to be recognized. In the technique described in PTL 2, an object detection means performs recognition processing as to whether there is a predetermined object in an input image. The object range determination means determines the object range of the detection object based on the detection result of the object detection means.

PTL 2 describes that the object range determination means uses, for example, the position and size of the object output from the object detection means to expand the detection window in which the object is detected vertically and horizontally at a predetermined ratio to set the detection window as the object range. According to FIG. 7(A) of PTL 2, the detection window has a rectangular shape.

### CITATION LIST

### Patent Literature

PTL 1: JP 2019-220014 A
PTL 2: JP 2016-018538 A

### SUMMARY OF INVENTION

### Technical Problem

An object of this disclosure is to improve the technique described in the above-described prior art documents.

### Solution to Problem

According to one aspect of the present disclosure,
there is provided an information processing system including:
a feature extraction means for extracting a feature of a subject shown in an image; and
an estimation means for estimating a type of the subject, and a shape type and a shape parameter relevant to the subject using the extracted feature.

According to one aspect of the present disclosure,
there is provided an information processing device including:
a feature extraction means for extracting a feature of a subject shown in an image; and
an estimation means for estimating a type of the subject, and a shape type and a shape parameter relevant to the subject using the extracted feature.

According to one aspect of the present disclosure,
there is provided an information processing method for causing at least one computer to execute:
extracting a feature of a subject shown in an image; and
estimating a type of the subject, and the shape type and the shape parameter relevant to the subject using the extracted feature.

According to one aspect of the present disclosure, there is provided a recording medium having recorded therein a program causing at least one computer to execute:
extracting a feature of a subject shown in an image; and
estimating a type of the subject, and the shape type and the shape parameter relevant to the subject using the extracted feature.

### BRIEF DESCRIPTION OF DRAWINGS

FIG. 1 is a diagram illustrating an outline of an information processing system according to a first example embodiment.

FIG. 2 is a diagram illustrating an outline of an information processing device according to the first example embodiment.

FIG. 3 is a diagram illustrating an outline of information processing according to the first example embodiment.

FIG. 4 is a diagram illustrating a configuration example of the information processing system according to the first example embodiment.

FIG. 5 is a diagram illustrating a physical configuration example of the information processing device according to the first example embodiment.

FIG. 6 is a flowchart illustrating an example of information processing according to the first example embodiment.

FIG. 7 is a diagram illustrating a first example of a type, a shape type, and a shape parameter of a subject estimated for the subject.

FIG. 8 is a diagram illustrating a second example of a type, a shape type, and a shape parameter of a subject estimated for the subject.

FIG. 9 is a diagram illustrating a third example of a type, a shape type, and a shape parameter of a subject estimated for the subject.

FIG. 10 is a diagram illustrating a configuration example of an information processing system according to a second example embodiment.

FIG. 11 is a diagram illustrating a functional configuration example of a shape estimation unit according to the second example embodiment.

FIG. 12 is a diagram illustrating an example of association information.

FIG. 13 is a diagram illustrating first to third regions in the second example illustrated in FIG. 8.

FIG. 14 is a flowchart illustrating an example of information processing according to the second example embodiment.

FIG. 15 is a flowchart illustrating an example of shape estimation processing according to the second example embodiment.

FIG. 16 is a diagram illustrating a configuration example of an information processing system according to a third example embodiment.

FIG. 17 is a diagram illustrating a functional configuration example of a shape estimation unit according to the third example embodiment.

FIG. 18 is a flowchart illustrating an example of information processing according to the third example embodiment.

FIG. 19 is a flowchart illustrating an example of shape estimation processing according to the third example embodiment.

FIG. 20 illustrates a functional configuration example of a parameter estimation unit 233 according to the second and third example embodiments.

FIG. 21 is a flowchart illustrating an example of parameter estimation processing according to the second and third example embodiments.

FIG. 22 is a diagram illustrating a configuration example of an information processing system according to a fifth example embodiment.

FIG. 23 is a flowchart illustrating an example of information processing according to the fifth example embodiment.

FIG. 24 is a diagram illustrating a configuration example of an information processing system according to a sixth example embodiment.

FIG. 25 is a flowchart illustrating an example of recognition processing according to the sixth example embodiment.

FIG. 26 is a diagram illustrating a configuration example of an information processing system according to a first modification.

### EXAMPLE EMBODIMENT

Hereinafter, example embodiments of the present disclosure will be described with reference to the drawings. In all the drawings, the same components are denoted by the same reference numerals, and the description thereof will be omitted as appropriate.

### First Example Embodiment

### Overview

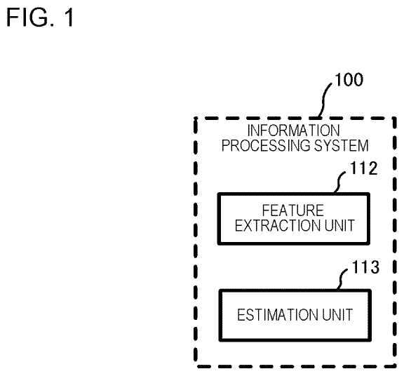

FIG. 1 is a diagram illustrating an outline of an information processing system 100 according to a first example embodiment. The information processing system 100 includes a feature extraction unit 112 and an estimation unit 113.

The feature extraction unit 112 extracts features of a subject shown in an image. The estimation unit 113 uses the extracted features to estimate a type of the subject and a shape type and shape parameters relevant to the subject.

According to the information processing system 100, it is possible to recognize a rough shape that favorably approximates the outer edge of the subject included in the image.

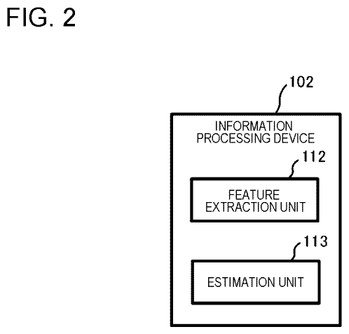

FIG. 2 is a diagram illustrating an outline of an information processing device 102 according to the first example embodiment. The information processing device 102 includes a feature extraction unit 112 and an estimation unit 113.

The feature extraction unit 112 extracts features of a subject shown in an image. The estimation unit 113 uses the extracted features to estimate a type of the subject and a shape type and shape parameters relevant to the subject.

According to the information processing device 102, it is possible to recognize a rough shape that favorably approximates the outer edge of the subject included in the image.

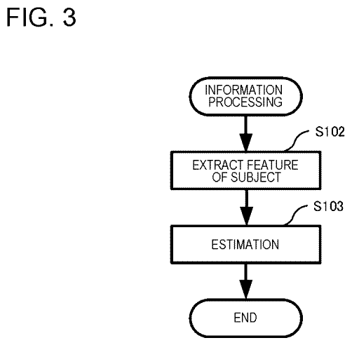

FIG. 3 is a diagram illustrating an outline of information processing according to the first example embodiment.

The feature extraction unit 112 extracts features of a subject shown in an image (step S102).

The estimation unit 113 uses the extracted features to estimate a type of the subject and a shape type and shape parameters relevant to the subject (step S103).

According to the information processing, it is possible to recognize a rough shape that favorably approximates the outer edge of the subject included in the image.

Hereinafter, a detailed example of the information processing system 100 according to the first example embodiment will be described.

### Details

In general, in a case of recognizing a shape of an object or the like in an image, it is often difficult to recognize a precise shape of the object because a processing load increases. In order to grasp the shape of the object, it may be desirable to recognize the rough shape of the object.

However, PTL 1 does not disclose a technique for recognizing the rough shape of such an object.

On the other hand, PTL 2 discloses, as described above, that a rectangular detection window is vertically and horizontally expanded at a predetermined ratio to be an object range. PTL 2 discloses that the reason why the detection window is not set to the object range as it is but expanded to a predetermined range to set the object range is that the region of the human body may easily protrude from the detection window of the object depending on the posture of the four limbs of the human body.

However, as exemplified in PTL 2 that the region of the human body protrudes from the rectangular detection window depending on the posture, the shape of the object may be various rough shapes depending on the state even if the object is the same. Therefore, for example, depending on the posture of the human body, even if the aspect ratio of the rectangular detection window is increased, the region of the human body may greatly protrude from the detection window, or the region other than the region of the human body may become large in the detection window.

As described above, in the techniques described in PTLs 1 and 2, it is difficult to recognize a rough shape that favorably approximates the outer edge of the subject included in the image.

In view of these circumstances, an object of the present disclosure is to provide an information processing system, an information processing device, an information processing method, a recording medium, and the like that solve recognition of a rough shape that favorably approximates an outer edge of a subject included in an image.

### Configuration Example of Information Processing System 100 According to First Example Embodiment

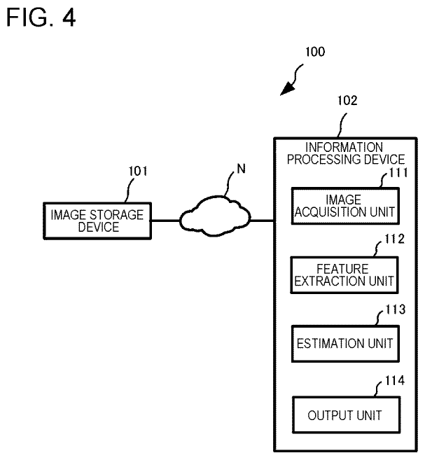

FIG. 4 is a diagram illustrating a configuration example of the information processing system 100 according to the first example embodiment. The information processing system 100 is a system for recognizing a rough shape of a subject included in a processing target image (hereinafter, it is also referred to as a “processing target image”).

The “subject” is, for example, an object shown in an image. The object includes, for example, at least one of a person and an object. The subject may be, for example, a predetermined portion of an object such as an iris or a face.

The information processing system 100 includes an image storage device 101 and an information processing device 102.

The image storage device 101 and the information processing device 102 are connected to each other via a network N configured by wire, radio, or a combination thereof, and transmit and receive information to and from each other via the network N.

### Functional Configuration Example of Image Storage Device 101 According to First Example Embodiment

The image storage device 101 is a device for storing a processing target image. The processing target image is, for example, an image generated by photographing by an imaging device such as a camera. The image storage device 101 may store the processing target image in advance.

The information processing system 100 may include an imaging device connected to the network N instead of the image storage device 101 or together with the image storage device 101.

### Functional Configuration Example of Information Processing Device 102 According to First Example Embodiment

The information processing device 102 is a device that performs information processing for recognizing the rough shape of the subject included in the processing target image. The information processing device 102 functionally includes an image acquisition unit 111, a feature extraction unit 112, an estimation unit 113, and an output unit 114.

The image acquisition unit 111 acquires a processing target image. The image acquisition unit 111 according to the present example embodiment acquires a processing target image from the image storage device 101.

The feature extraction unit 112 extracts the feature of each of one or more subjects shown in the processing target image from the processing target image.

The estimation unit 113 uses the feature extracted by the feature extraction unit 112 for each of one or more subjects to estimate a type of the subject and a shape type and a shape parameter relevant to the subject for each of one or more subjects.

The “subject type” may be determined in advance, and is the type of the object in the present example embodiment. Examples of the subject type according to the present example embodiment include a person, an umbrella, a bag, a dog, an automobile, and a bicycle.

The shape type and the shape parameter relevant to the subject are information for specifying a shape according to the rough shape of the subject. The “rough shape of the subject” is an approximate shape indicated by an outer edge of the subject.

The “shape type” is a predetermined type of the shape.

Examples of the shape type according to the present example embodiment include a polygon (for example, a triangle, a quadrangle, a pentagon, or the like), a circle, an ellipse, a curve, a closed curve, and a straight line.

The triangles may, in more detail, be equilateral triangles, isosceles triangles, etc. Similarly, the quadrangle may be a square, a rectangle, a parallelogram, a trapezoid, or the like.

The closed curve shape means a shape formed by the closed curve. The closed curve is a closed line including a curve in at least a part, that is, a line having a common start point and end point and including a curve in at least a part. The curve or the curve included in the closed curve is, for example, a Bezier curve spline curve.

The shape type may include at least one of a polygon, a circle, an ellipse, a curve, a closed curve, and a straight line.

The “shape parameter” is a parameter for specifying a shape indicated by a shape type relevant to the subject in the processing target image. In other words, the shape parameter is a value for specifically defining the shape indicated by the shape type in the processing target image.

Examples of the shape parameter according to the present example embodiment include the size and rotation angle of the shape indicated by the shape type, and the position in the image. The rotation angle may be expressed by, for example, an angle of a reference direction indicating a predetermined reference direction for each shape type.

The shape parameter may include at least one of the size and rotation angle of the shape indicated by the shape type and the position in the image.

The output unit 114 outputs the type, the shape type, and the shape parameter of the subject estimated by the estimation unit 113 for each of one or more subjects. The output method may be, for example, display or transmission to another device (not illustrated) such as a terminal. The output method is not limited thereto.

The functional configuration example of the information processing system 100 according to the first example embodiment has been mainly described above. From here, a physical configuration example of the information processing system 100 according to the first example embodiment will be described.

### Physical Configuration Example of Information Processing System 100 According to First Example Embodiment

The information processing system 100 physically includes an image storage device 101 and an information processing device 102 connected via a network N. Each of the image storage device 101 and the information processing device 102 includes, for example, a single physically different device.

The image storage device 101 and the information processing device 102 may be physically configured by a single device. In this case, the image storage device 101 and the information processing device 102 may be connected using an internal bus 1010 described later instead of the network N. One or both of the image storage device 101 and the information processing device 102 may include a plurality of devices physically connected via an appropriate communication line such as the network N.

The image storage device 101 according to the present example embodiment may be physically configured similarly to the information processing device 102. A physical configuration example of the information processing device 102 will be described with reference to the drawings.

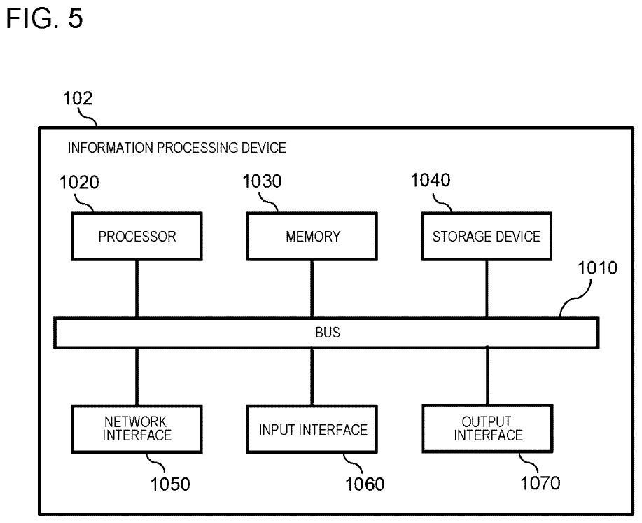

FIG. 5 is a diagram illustrating a physical configuration example of the information processing device 102 according to the first example embodiment. The information processing device 102 physically includes, for example, a bus 1010, a processor 1020, a memory 1030, a storage device 1040, a network interface 1050, an input interface 1060, and an output interface 1070.

The bus 1010 is a data transmission path through which the processor 1020, the memory 1030, the storage device 1040, the network interface 1050, the input interface 1060, and the output interface 1070 mutually transmit and receive data. However, the method of connecting the processor 1020 and the like to each other is not limited to the bus connection.

The processor 1020 is a processor achieved by a central processing unit (CPU), a graphics processing unit (GPU), or the like.

The memory 1030 is a main storage device achieved by a random access memory (RAM) or the like.

The storage device 1040 is an auxiliary storage device achieved by a hard disk drive (HDD), a solid state drive (SSD), a memory card, a read only memory (ROM), or the like. The storage device 1040 stores a program module for implementing a function of a device including the storage device. The processor 1020 reads and executes the program module in the memory 1030, thereby implementing the functions related to the program modules.

The network interface 1050 is an interface for connecting the device including this interface to the network N.

The input interface 1060 is an interface for the user to input information. The input interface 1060 includes, for example, one or more of a touch panel, a keyboard, a mouse, and the like.

The output interface 1070 is an interface for presenting information to the user. The output interface 1070 includes, for example, a liquid crystal panel, an organic electro-luminescence (EL) panel, or the like.

The configuration example of the information processing system 100 according to the first example embodiment has been mainly described above. From here, an operation example of the information processing system 100 according to the first example embodiment will be described.

### Operation Example of Information Processing System 100 According to First Example Embodiment

The information processing device 102 executes information processing for recognizing the rough shape of the subject included in the processing target image. The information processing is started, for example, in response to an instruction from the user.

The information processing may include processing of generating a processing target image by imaging (imaging processing). In this case, the information processing may be repeatedly executed in real time.

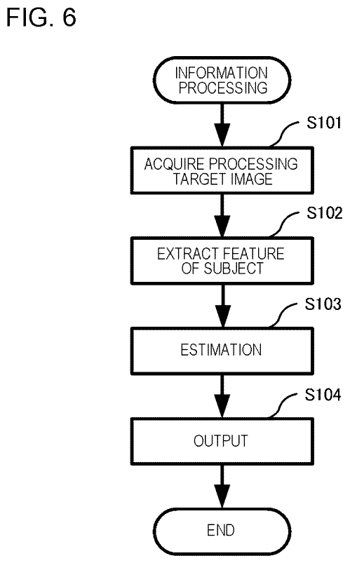

FIG. 6 is a flowchart illustrating an example of information processing according to the first example embodiment.

The image acquisition unit 111 acquires the processing target image from the image storage device 101 via the network N (step S101).

The feature extraction unit 112 extracts the feature of each of one or more subjects shown in the processing target image acquired in step S101 from the processing target image (step S102).

In step S102, the technology for extracting the feature of the subject from the processing target image may be a general technology. For example, the feature extraction unit 112 uses the processing target image as an input and extracts the feature of the subject using the image processing model. The image processing model is a trained machine learning model for extracting a feature of the subject included in an image from the image. At the time of training the image processing model, supervised learning for extracting a feature of the subject included in training images may be performed.

The estimation unit 113 estimates the type of the subject and the shape type and the shape parameter relevant to the subject for each of one or more subjects using the feature extracted in step S102 (step S103).

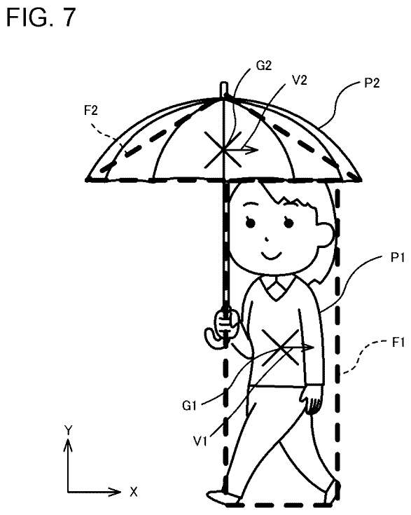

FIG. 7 is a diagram illustrating a first example of a type, a shape type, and a shape parameter of a subject estimated for the subject. In the example illustrated in FIG. 7, a person holding an umbrella included in the processing target image is extracted and illustrated, and two subjects P1 and P2 are included. The type of the subject P1 is a person. The type of the subject P2 is an umbrella.

The shape type associated with the subject P1 is a rectangle F1. The shape parameter associated with the subject P1 includes a parameter (value) for specifying the rectangle F1 associated with the subject P1 in the processing target image. This parameter includes, for example, the position of a barycenter G1 of the rectangle F1, the lengths in the lateral direction and the longitudinal direction of the rectangle F1, and the rotation angle. In the example illustrated in FIG. 7, a reference direction V1 for the rectangle F1 is determined to be parallel to the base, and the rotation angle is 0 degrees (for example, in the same direction as the X axis of the coordinate system defined for the processing target image).

The shape type associated with the subject P2 is an isosceles triangle F2. The shape parameter associated with the subject P2 includes a parameter (value) for specifying the isosceles triangle F2 associated with the subject P2 in the processing target image. This parameter includes, for example, the position of a barycenter G2 of the isosceles triangle F2, the length of the base and the height of the isosceles triangle F2, and the rotation angle. In the example illustrated in FIG. 7, a reference direction V2 of the isosceles triangle F2 is defined parallel to the base, and the rotation angle is 0 degrees (for example, in the same direction as the X axis of the coordinate system defined for the processing target image).

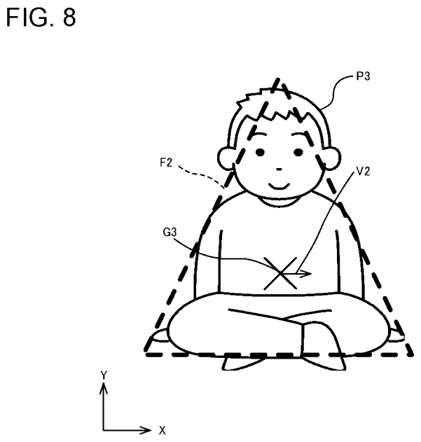

FIG. 8 is a diagram illustrating a second example of the type, the shape type, and the shape parameter of the subject estimated for the subject. In the example illustrated in FIG. 8, a seated person is extracted and illustrated, and the person is included as the subject P3.

The shape type associated with the subject P3 is an isosceles triangle F2. The shape parameter associated with the subject P3 includes a parameter (value) for specifying the isosceles triangle F2 associated with the subject P3 in the processing target image. This parameter includes, for example, the position of a barycenter G3 of the isosceles triangle F2, the length of the base and the height of the isosceles triangle F2, and the rotation angle. In the example illustrated in FIG. 8, a reference direction V2 of the isosceles triangle F2 is defined parallel to the base, and the rotation angle is 0 degrees (for example, in the same direction as the X axis of the coordinate system defined for the processing target image).

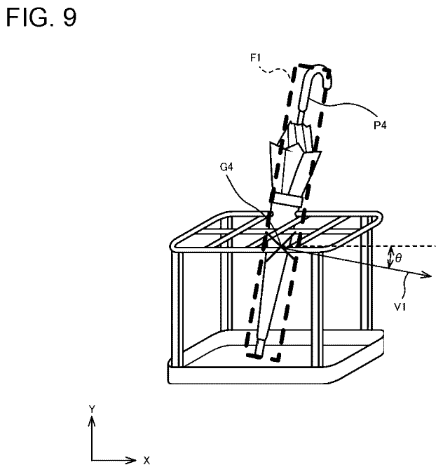

FIG. 9 is a diagram illustrating a third example of the type, the shape type, and the shape parameter of the subject estimated for the subject. In the example illustrated in FIG. 9, the umbrella erected on the umbrella stand is extracted and illustrated, and the umbrella is included as the subject P4.

The shape type associated with the subject P4 is a rectangle F1. The shape parameter associated with the subject P4 includes a parameter (value) for specifying the rectangle F1 associated with the subject P4 in the processing target image. This parameter includes, for example, the position of a barycenter G4 of the rectangle F1, the lengths in the lateral direction and the longitudinal direction of the rectangle F1, and the rotation angle. In the example illustrated in FIG. 9, an example is illustrated in which the reference direction V1 for the rectangle F1 is determined to be parallel to the base, and the rotation angle is 0 degrees. For example, 0 is an angle formed around a predetermined direction with respect to the positive direction of the X axis of the coordinate system defined for the processing target image.

The barycenters G1 to G4 are examples of representative positions determined in advance for the shape type. The representative position is not limited to the barycenter, and may be determined with respect to the shape indicated by the shape type.

As described above, for each of one or more subjects, in addition to the type of the subject, the estimation unit 113 specifies a shape type relevant to the subject among shape types determined in advance for specifying the rough shape of the subject. Furthermore, the estimation unit 113 estimates a parameter for specifying a shape indicated by the specified shape type in the processing target image. As a result, the rough shape of the subject in the processing target image can be estimated using various shapes included in the shape type.

As can be seen from these examples, the number of shape parameters may be different depending on the shape type. In a case where the number of shape parameters varies depending on the shape type, the shape parameter may be represented by a vector having a length relevant to the number of shape parameters, or may be represented by a fixed-length vector common to the shape types. In a case where a fixed-length vector is employed, the size of this vector may be the same as the number of maximum shape parameters among all predetermined shape types. A predetermined value such as a blank or a null value may be stored in an unused element of the fixed-length vector.

Reference is made again to FIG. 6.

The output unit 114 outputs the type, the shape type, and the shape parameter of the subject estimated for each of one or more subjects in step S103 (step S104).

For example, in a case where the output is display, the output unit 114 causes a shape specified by the shape type and the shape parameter estimated for each of the one or more subjects to be displayed in an overlapping manner with the processing target image. As a result, it is possible to display the shape indicating the rough shape of each subject shown in the processing target image in an overlapping manner together with the processing target image.

### Operation and Effect

As described above, according to the present example embodiment, the information processing system 100 includes the feature extraction unit 112 and the estimation unit 113. The feature extraction unit 112 extracts features of a subject shown in an image. The estimation unit 113 uses the extracted features to estimate a type of the subject and a shape type and shape parameters relevant to the subject.

As a result, the rough shape of the subject in the processing target image can be estimated using any of various shapes included in the shape type. Therefore, it is possible to recognize a rough shape that favorably approximates the outer edge of the subject included in the image.

According to the present example embodiment, the shape type includes at least one of a polygon, a circle, an ellipse, a curve, a closed curve, and a straight line. The shape parameter includes at least one of the size and rotation angle of the shape indicated by the shape type and the position in the image.

As a result, the rough shape of the subject in the processing target image can be estimated using any of various shapes included in the shape type. Therefore, it is possible to recognize a rough shape that favorably approximates the outer edge of the subject included in the image.

According to the present example embodiment, the shape parameter is represented by a fixed-length vector common to shape types.

As a result, regardless of the shape type, the shape parameters can be treated as variables of the same size. Therefore, it is possible to facilitate processing for recognizing a rough shape that favorably approximates the outer edge of the subject included in the image.

### Second Example Embodiment

A first detailed example of a method in which the estimation unit estimates a type of a subject, and a shape type and a shape parameter relevant to the subject will be described.

In the present example embodiment, in order to simplify the description, points different from the first example embodiment will be mainly described, and the description overlapping with the first example embodiment will be appropriately omitted.

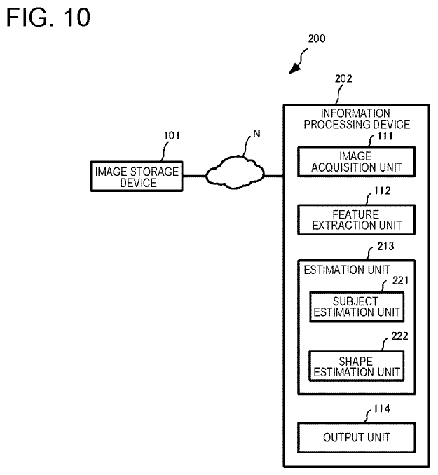

FIG. 10 is a diagram illustrating a configuration example of an information processing system 200 according to the second example embodiment. The information processing system 200 includes an information processing device 202 in place of the information processing device 102 according to the first example embodiment. The information processing device 202 functionally includes an estimation unit 213 in place of the estimation unit 113 according to the first example embodiment. Except for these, the information processing system 200 according to the present example embodiment may be configured similarly to the information processing device 102 according to the first example embodiment.

The estimation unit 213 has a function similar to that of the estimation unit 113 according to the first example embodiment. The estimation unit 213 functionally includes a subject estimation unit 221 and a shape estimation unit 222.

The subject estimation unit 221 estimates the type of the subject using the feature extracted by the feature extraction unit 112 for each of one or more subjects.

The shape estimation unit 222 estimates a shape type and a shape parameter relevant to one or more subjects based on the type of the subject estimated by the subject estimation unit 221 for each of the subjects.

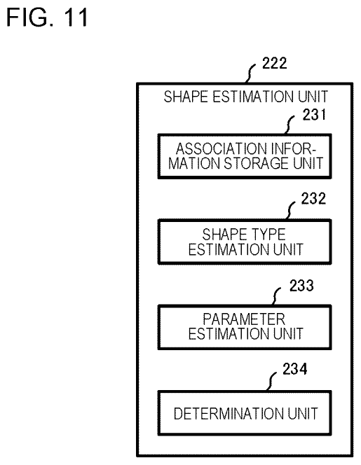

FIG. 11 is a diagram illustrating a functional configuration example of the shape estimation unit 222 according to the second example embodiment. The shape estimation unit 222 functionally includes an association information storage unit 231, a shape type estimation unit 232, a parameter estimation unit 233, and a determination unit 234.

The association information storage unit 231 is a storage unit for storing association information 231a.

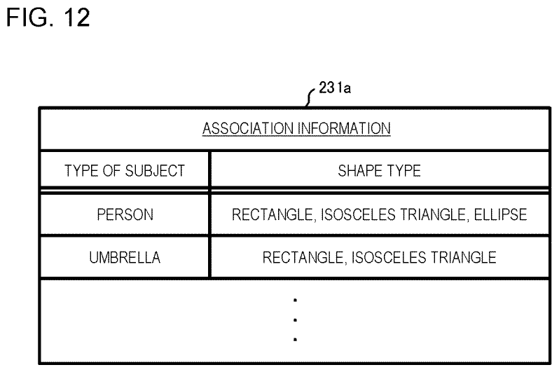

FIG. 12 is a diagram illustrating an example of the association information 231a. The association information 231a is information that associates a subject type with one or more shape types. As a result, the association information 231a is information that defines a shape type used to recognize the rough shape of the subject for each type of the subject.

In the example of the association information 231a illustrated in FIG. 12, the types of the subject include “person” and “umbrella”. The subject type “person” is associated with “rectangle”, “isosceles triangle”, and “ellipse” as shape types. A subject type “person” is associated with “rectangle” and “isosceles triangle” as shape types.

Reference is made again to FIG. 11.

Based on the type of the subject estimated by the subject estimation unit 221 for each of the one or more subjects, the shape type estimation unit 232 estimates one or more shape types relevant to the subject.

Based on the type of the subject estimated by the subject estimation unit 221 and the association information 231a for each of the one or more subjects, the shape type estimation unit 232 according to the present example embodiment estimates one or more shape types relevant to the subject.

The parameter estimation unit 233 estimates, for each of one or more subjects, a shape parameter relevant to the subject for one or more shape types estimated by the shape type estimation unit 232. For example, the parameter estimation unit 233 may use a matching score to be described later in order to estimate the shape parameter.

In a case where there are a plurality of estimated shape types, the determination unit 234 determines a shape type and a shape parameter relevant to a subject from combinations of the plurality of estimated shape types and the shape parameters estimated for each of the plurality of estimated shape types.

The determination unit 234 uses the matching score to determine the combination of the shape type and the shape parameter relevant to the subject. That is, the determination unit 234 determines the shape type and the shape parameter relevant to the subject based on the shape parameter estimated by the parameter estimation unit 233 for each of the plurality of estimated shape types and the matching score.

The matching score is a value indicating the degree to which the shape is matched with the outer edge of the subject. For example, the higher the degree to which the shape is matched with the outer edge of the subject, the higher the matching score, and the lower the degree to which the shape is matched with the outer edge of the subject, the lower the matching score.

The matching score is obtained according to a rough shape estimation criterion defined using the areas of at least two regions of the first region to the third region.

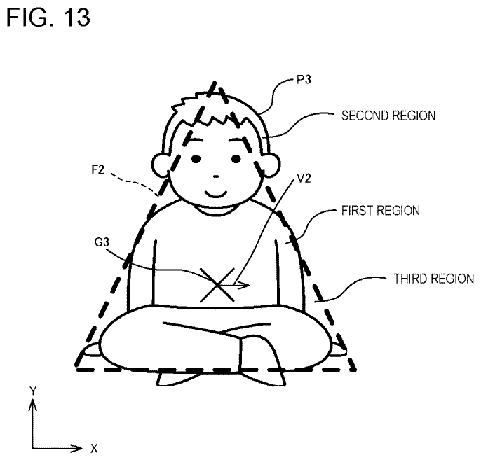

FIG. 13 is a diagram illustrating first to third regions in the second example illustrated in FIG. 8. The first region is a region where the shape and the subject overlap each other. The second region is a region in the subject protruding from the shape. The third region is a region in the shape protruding from the subject.

For example, the rough shape estimation criterion may be defined so that the ratio of the first region to the area of the first region or the area in the shape is the maximum and the matching score of the shape that most covers the subject is the maximum.

For example, the rough shape estimation criterion may be a criterion in which the larger the area of the first region, the larger the matching score, and the smaller the area of the second region (or the third region), the larger the matching score. For example, the rough shape estimation criterion may be a criterion in which the smaller the difference in area between the second region and the third region, the larger the matching score.

In the present example embodiment, the determination unit 234 obtains the matching score for each of the plurality of combinations of the estimated shape type and shape parameters. Then, the determination unit 234 determines a plurality of combinations of the shape type and the shape parameter having the maximum matching score as the shape type and the shape parameter relevant to the subject.

The functional configuration example of the information processing system 200 according to the second example embodiment has been mainly described above. The information processing system 200 may be physically configured similarly to the information processing system 100 according to the first example embodiment. From here, an operation example of the information processing system 200 according to the second example embodiment will be described.

### Operation Example of Information Processing System 200 According to Second Example Embodiment

Similarly to the information processing device 102 according to the first example embodiment, the information processing device 202 executes information processing for recognizing the rough shape of the subject included in the processing target image.

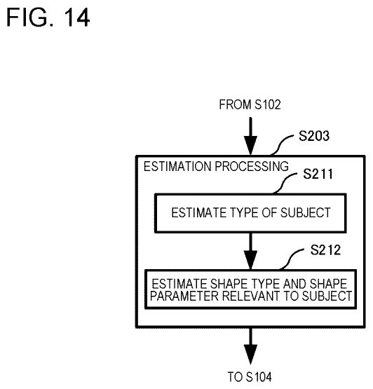

FIG. 14 is a flowchart illustrating an example of information processing according to the second example embodiment. The information processing according to the second example embodiment includes estimation processing (step S203) in place of the estimation processing (step S103) according to the first example embodiment. Except for this, the information processing according to the second example embodiment may be similar to the information processing according to the first example embodiment. FIG. 14 illustrates details of the estimation processing (step S203).

Similarly to step S103 according to the first example embodiment, the estimation unit 213 estimates the type of the subject, and the shape type and the shape parameter relevant to the subject using the feature extracted in step S102 (step S203).

As illustrated in the drawing, the subject estimation unit 221 estimates the type of the subject using the feature extracted for each of one or more subjects in step S102 (step S211).

In step S211, the technique for estimating the type of the subject using the feature of the subject may be a general technique. For example, the subject estimation unit 221 extracts the type of the subject using the type estimation model with the feature of the subject as an input. The type estimation model is a machine learning model that performs training for estimating the type of the subject based on the feature of the subject. At the time of training of the type estimation model, supervised learning for estimating the type of the subject may be performed using the feature of the subject extracted from the training images.

The shape estimation unit 222 estimates a shape type and a shape parameter relevant to one or more subjects based on the type of the subject estimated for each of the subjects in step S211 (step S212; shape estimation processing).

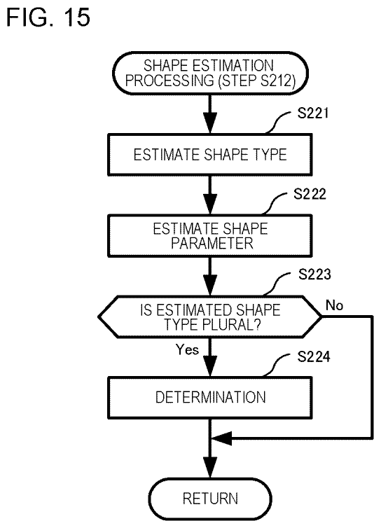

FIG. 15 is a flowchart illustrating an example of shape estimation processing (step S212) according to the second example embodiment.

Based on the type of the subject estimated for each of the one or more subjects in step S211, the shape type estimation unit 232 estimates one or more shape types relevant to the subject (step S221).

Specifically, for example, the shape type estimation unit 232 refers to the association information 231a and specifies one or more shape types associated with the type of each subject estimated in step S211. Accordingly, the shape type estimation unit 232 estimates one or more shape types relevant to the subject.

For example, in a case where the estimated subject type is “person”, referring to the association information 231a illustrated in FIG. 12, the shape type estimation unit 232 estimates a rectangle, an isosceles triangle, and an ellipse as shape types.

Reference is made again to FIG. 15.

The parameter estimation unit 233 estimates a shape parameter relevant to one or more shape types estimated for each of one or more subjects in step S211 (step S222).

The method of estimating the shape parameter in step S222 may be various methods such as a method of changing the shape parameter and a method using a machine learning model.

For example, in a case where a method of changing a shape parameter is used, the parameter estimation unit 233 estimates the shape parameter so that the matching score is maximized for each of the estimated one or more shape types. Specifically, for example, the parameter estimation unit 233 refers to the processing target image, changes each shape parameter for each shape type, for example, at a predetermined interval, and obtains the matching score for each shape parameter. Then, the parameter estimation unit 233 estimates the shape parameter having the maximum matching score for each shape type.

For example, in a case where a machine learning model is used, the parameter estimation unit 233 uses the estimated one or more shape types and the processing target image as inputs, and estimates a shape parameter relevant to the subject for each of the estimated one or more shape types using the parameter estimation model. The parameter estimation model is a trained machine learning model for estimating a shape parameter relevant to the subject based on the shape type.

At the time of training the parameter estimation model, supervised learning may be performed to estimate a shape parameter relevant to a subject for each of one or more shape types using the training images and one or more shape types estimated for the subject included in the training images. In this training, for example, training may be performed to estimate the shape parameter so that the matching score is maximized.

The determination unit 234 determines whether there are a plurality of shape types estimated in step S221 (step S223). In a case where the number of estimated shape types is not plural (step S223; No), the determination unit 234 ends the shape estimation processing (step S212), and returns to the information processing. As illustrated in FIG. 14, step S104 similar to that in the first example embodiment is continuously executed.

Reference is made again to FIG. 15.

In a case where there are a plurality of estimated shape types (step S223; Yes), the determination unit 234 determines the shape type and the shape parameter relevant to the subject (step S224), and ends the shape estimation processing (step S212). The determination unit 234 returns to the information processing, and as illustrated in FIG. 14, step S104 similar to that in the first example embodiment is continuously executed.

Specifically, for example, the determination unit 234 refers to the processing target image, and obtains the matching score for each of the combinations of the plurality of shape types and shape parameters estimated in steps S211 and S212. The determination unit 234 determines a combination of the shape type and the shape parameter having the maximum matching score as the shape type and the shape parameter relevant to the subject. Thus, the determination unit 234 determines the shape type and the shape parameter relevant to the subject from the plurality of combinations of shape types and shape parameters estimated in steps S211 and S212.

The parameter estimation unit 233 may be configured to output, as a result of estimation, a combination of the shape type and the shape parameter that maximizes the matching score. In this case, the information processing device 202 may not include the determination unit 234. The information processing may not include steps S223 and S224.

### Operation and Effect

As described above, according to the present example embodiment, the estimation unit 213 includes the subject estimation unit 221 and the shape estimation unit 222. The subject estimation unit 221 estimates the type of the subject using the extracted feature. The shape estimation unit 222 estimates a shape type and a shape parameter relevant to a subject based on the estimated type of the subject.

As a result, the rough shape of the subject in the processing target image can be estimated using any of various shapes included in the shape type. Therefore, it is possible to recognize a rough shape that favorably approximates the outer edge of the subject included in the image.

According to the present example embodiment, the shape estimation unit 222 includes the shape type estimation unit 232 and the parameter estimation unit 233. Based on the estimated type of the subject, the shape type estimation unit 232 estimates one or more shape types relevant to the subject. The parameter estimation unit 233 estimates the shape parameter relevant to the subject for the estimated one or more shape types.

As a result, the rough shape of the subject in the processing target image can be estimated using any of various shapes included in the shape type. Therefore, it is possible to recognize a rough shape that favorably approximates the outer edge of the subject included in the image.

According to the present example embodiment, the shape type estimation unit 232 estimates one or more shape types relevant to a subject based on the estimated type of the subject and the association information 231a that associates the type of the subject with one or more shape types.

As a result, the rough shape of the subject in the processing target image can be estimated using any of various shapes included in the shape type. Therefore, it is possible to recognize a rough shape that favorably approximates the outer edge of the subject included in the image.

According to the present example embodiment, the shape estimation unit 222 further includes the determination unit 234. In a case where there are a plurality of estimated shape types, the determination unit 234 determines the shape type and the shape parameter relevant to the subject based on the shape parameter estimated for each of the plurality of shape types and the matching score indicating the degree of matching of the shape to the outer edge of the subject.

As a result, it is possible to estimate the rough shape of the subject in the processing target image by using a shape that is highly matched with the outer edge of the subject among various shapes included in the shape type. Therefore, it is possible to recognize a rough shape that favorably approximates the outer edge of the subject included in the image.

According to the present example embodiment, the matching score is a value obtained according to a rough shape estimation criterion defined using the areas of at least two regions among (A) the first region, (B) the second region, and (C) the third region. (A) The first region is a region where the shape and the subject overlap each other. (B) The second region is a region in the subject protruding from the shape. (C) The third region is a region in the shape protruding from the subject.

As a result, it is possible to estimate a rough shape that favorably approximates the outer edge of the subject included in the processing target image using the matching score. Therefore, it is possible to recognize a rough shape that favorably approximates the outer edge of the subject included in the image.

### Third Example Embodiment

A second detailed example of a method in which the estimation unit estimates a type of a subject, and a shape type and a shape parameter relevant to the subject will be described.

In the present example embodiment, in order to simplify the description, points different from other example embodiments will be mainly described, and description overlapping with other example embodiments will be appropriately omitted.

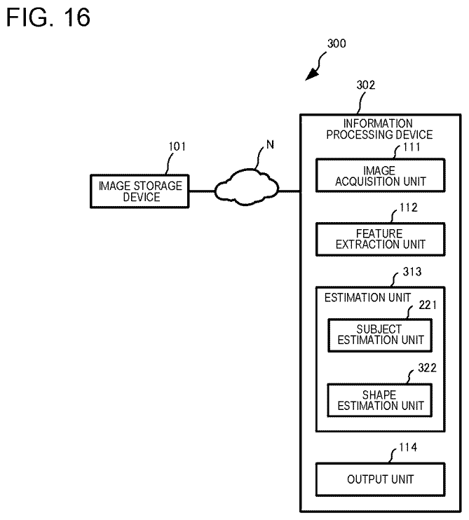

FIG. 16 is a diagram illustrating a configuration example of an information processing system 300 according to the third example embodiment. The information processing system 300 includes an information processing device 302 in place of the information processing device 102 according to the first example embodiment. The information processing device 302 functionally includes an estimation unit 313 in place of the estimation unit 113 according to the first example embodiment. Except for these, the information processing system 300 according to the present example embodiment may be configured similarly to the information processing device 102 according to the first example embodiment.

The estimation unit 313 has a function similar to that of the estimation unit 113 according to the first example embodiment. The estimation unit 313 functionally includes a subject estimation unit 221 similar to that of the second example embodiment and a shape estimation unit 322.

The shape estimation unit 322 estimates a shape type and a shape parameter relevant to one or more subjects based on the feature extracted by the feature extraction unit 112 for each of the subjects.

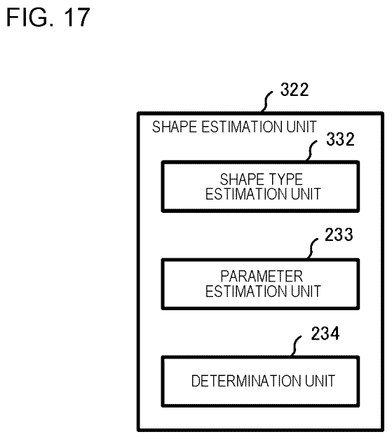

FIG. 17 is a diagram illustrating a functional configuration example of the shape estimation unit 322 according to the third example embodiment. The shape estimation unit 322 functionally includes a shape type estimation unit 332, and a parameter estimation unit 233 and a determination unit 234 similar to those of the second example embodiment.

The shape type estimation unit 332 uses the feature extracted by the feature extraction unit 112 for each of one or more subjects as an input, and estimates one or more shape types relevant to the subject using the shape type estimation model. The shape type estimation model is a trained machine learning model for estimating at least one shape type relevant to a subject shown in an image. As the shape type estimated by the shape type estimation model, types of a plurality of shapes may be determined in advance.

At the time of training the shape type estimation model, supervised learning may be performed to estimate one or more shape types relevant to the subject using the feature of the subject extracted from the training images.

The functional configuration example of the information processing system 300 according to the third example embodiment has been mainly described above. The information processing system 300 may be physically configured similarly to the information processing system 100 according to the first example embodiment. From here, an operation example of the information processing system 300 according to the second example embodiment will be described.

### Operation Example of Information Processing System 300 According to Third Example Embodiment

Similarly to the information processing device 102 according to the first example embodiment, the information processing device 302 executes information processing for recognizing the rough shape of the subject included in the processing target image.

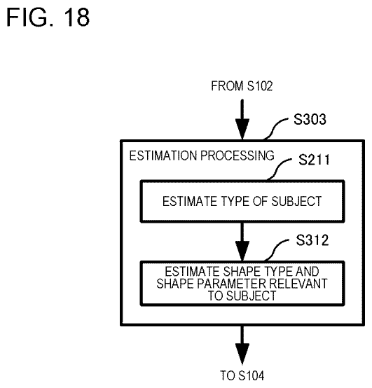

FIG. 18 is a flowchart illustrating an example of information processing according to the third example embodiment. The information processing according to the third example embodiment includes estimation processing (step S303) in place of the estimation processing (step S103) according to the first example embodiment. Except for this, the information processing according to the third example embodiment may be similar to the information processing according to the first example embodiment. FIG. 18 illustrates details of the estimation processing (step S303).

The subject estimation unit 221 executes step S211 similar to that of the second example embodiment.

The shape estimation unit 322 estimates a shape type and a shape parameter relevant to one or more subjects based on the feature extracted for each of the subjects in step S102 (step S312; shape estimation processing).

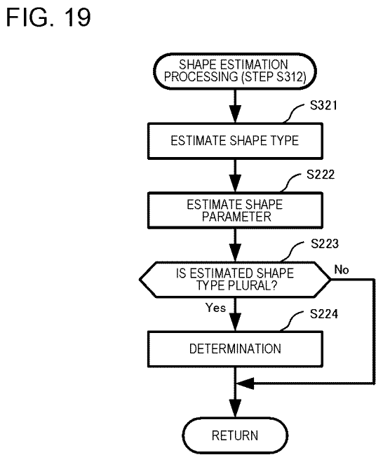

FIG. 19 is a flowchart illustrating an example of shape estimation processing (step S312) according to the third example embodiment.

The shape type estimation unit 332 uses the feature extracted for each of one or more subjects in step S102 as an input, and estimates one or more shape types relevant to the subject using the shape type estimation model (step S321).

The parameter estimation unit 233 and the determination unit 234 execute steps S222 to S224 similar to those of the second example embodiment, and return to the information processing. Subsequently, as illustrated in FIG. 18, step S104 similar to that of the first example embodiment is executed.

### Operation and Effect

As described above, according to the present example embodiment, the estimation unit 313 includes the subject estimation unit 221 and the shape estimation unit 322. The subject estimation unit 221 estimates the type of the subject using the extracted feature. The shape estimation unit 322 estimates a shape type and a shape parameter relevant to the subject based on the extracted feature.

As a result, the rough shape of the subject in the processing target image can be estimated using any of various shapes included in the shape type. Therefore, it is possible to recognize a rough shape that favorably approximates the outer edge of the subject included in the image.

According to the present example embodiment, the shape estimation unit 322 includes the shape type estimation unit 332 and the parameter estimation unit 233. Based on the extracted feature, the shape type estimation unit 332 estimates one or more shape types relevant to the subject. The parameter estimation unit 233 estimates the shape parameter relevant to the subject for the estimated one or more shape types.

As a result, the rough shape of the subject in the processing target image can be estimated using any of various shapes included in the shape type. Therefore, it is possible to recognize a rough shape that favorably approximates the outer edge of the subject included in the image.

According to the present example embodiment, the shape type estimation unit 332 estimates one or more shape types relevant to a subject by using a trained shape type estimation model for estimating at least one shape type relevant to the subject shown in an image with the extracted feature as an input.

As a result, the rough shape of the subject in the processing target image can be estimated using any of various shapes included in the shape type. Therefore, it is possible to recognize a rough shape that favorably approximates the outer edge of the subject included in the image.

### Fourth Example Embodiment

The configuration of the parameter estimation unit 233 described in the second and third example embodiments and details of the shape parameter estimation processing (step S222) executed by the parameter estimation unit 233 are various. In the fourth example embodiment, a detailed example of the parameter estimation unit 233 and the shape parameter estimation processing (step S222) will be described.

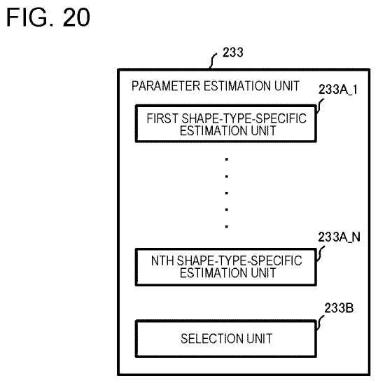

FIG. 20 illustrates a functional configuration example of the parameter estimation unit 233 according to the second and third example embodiments. The parameter estimation unit 233 includes first to Nth shape-type-specific estimation units 233A_1 to 233A_N (N is an integer of 1 or more) and a selection unit 233B.

The “first to Nth shape-type-specific estimation units 233A_1 to 233A_N” are also referred to as “shape-type-specific estimation unit 233A” unless otherwise specified.

The first to Nth shape-type-specific estimation units 233A_1 to 233A_N are associated with predetermined first to Nth shape types. The predetermined first to Nth shape types are relevant to, for example, all shape types included in the association information 231a. Each of the first to Nth shape-type-specific estimation units 233A_1 to 233A_N estimates a shape parameter relevant to a subject for each shape type associated with each shape type.

For example, it is assumed that three shape types included in the association information 231a are a rectangle, an isosceles triangle, and an ellipse. In this case, the parameter estimation unit 233 includes, for example, first to third shape-type-specific estimation units 233A_1 to 233A_3 associated with a rectangle, an isosceles triangle, and an ellipse.

That is, the first shape-type-specific estimation unit 233A_1 in this case is the shape-type-specific estimation unit 233A associated with the rectangle, and estimates the shape parameters for the rectangle. The second shape-type-specific estimation unit 233A_2 is the shape-type-specific estimation unit 233A associated with an isosceles triangle, and estimates a shape parameter for the isosceles triangle. The third shape-type-specific estimation unit 233A_3 is the shape-type-specific estimation unit 233A associated with an ellipse, and estimates a shape parameter for the ellipse.

As a method for estimating the shape parameter by each of the shape-type-specific estimation units 233A, various methods such as a method of changing the shape parameter as described above and a method using a machine learning model may be adopted.

In the case of using the machine learning model, for example, each of the shape-type-specific estimation units 233A uses the processing target image of the image of the subject included in the processing target image as an input, and estimates the shape parameter relevant to the subject for the associated shape type using the shape-type-specific parameter estimation model. The shape-type-specific parameter estimation model is a machine learning model that has trained to estimate a shape parameter relevant to a subject for an associated shape type.

At the time of training the shape-type-specific parameter estimation model, supervised learning for estimating the shape parameter relevant to the subject for the associated shape type may be performed using the training images or the image of the subject included in the training images. In this training, for example, training may be performed to estimate the shape parameter so that the matching score is maximized.

Based on one or more shape types estimated by the shape type estimation unit 232, the selection unit 233B selects the shape-type-specific estimation unit 233A to be used for estimating the shape parameter relevant to the subject.

For example, the selection unit 233B selects the shape-type-specific estimation unit 233A associated with each of one or more shape types estimated by the shape type estimation unit 232 from the first to Nth shape-type-specific estimation units 233A_1 to 233A_N.

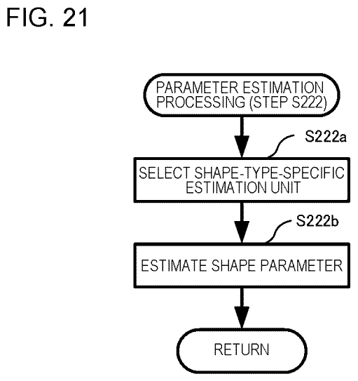

FIG. 21 is a flowchart illustrating an example of parameter estimation processing (step S222) according to the second and third example embodiments.

Based on one or more shape types estimated in step S221 or S321, the selection unit 233B selects the shape-type-specific estimation unit 233A to be used for estimating the shape parameter relevant to the subject (step S222a).

Specifically, for example, the selection unit 233B selects the shape-type-specific estimation unit 233A associated with one or more estimated shape types.

The shape-type-specific estimation unit 233A selected in step S222a estimates a shape parameter relevant to the subject for the associated shape type (step S222b), and returns to the shape estimation processing (step S212 or S312).

### Operation and Effect

As described above, according to the present example embodiment, the parameter estimation unit 233 includes the first to Nth shape-type-specific estimation unit 233A_1 to 233A_N and the selection unit 233B. Each of first to Nth shape-type-specific estimation units 233A_1 to 233A_N estimates a shape parameter relevant to a subject for a shape type associated with each of predetermined first to Nth shape types. Based on one or more shape types, the selection unit 233B selects the shape-type-specific estimation units 233A_1 to 233A_N to be used for estimating the shape parameter relevant to the subject.

As a result, the shape parameter can be estimated using the shape-type-specific estimation unit 233A specialized for each shape type. Therefore, it is possible to estimate a shape parameter that better matches the rough shape of the subject in the processing target image. It is possible to recognize a rough shape that better approximates the outer edge of the subject included in the image.

### Fifth Example Embodiment

A third detailed example of a method in which the estimation unit estimates a type of a subject, and a shape type and a shape parameter relevant to the subject will be described.

In the present example embodiment, in order to simplify the description, points different from other example embodiments will be mainly described, and description overlapping with other example embodiments will be appropriately omitted.

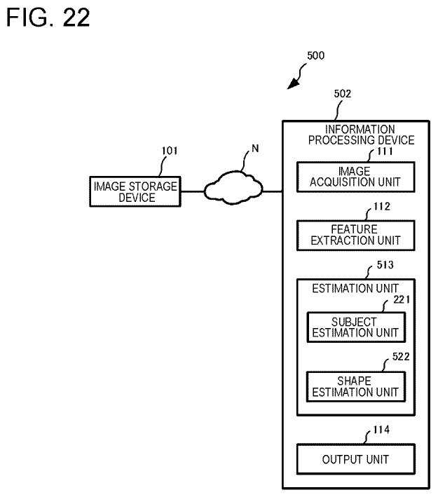

FIG. 22 is a diagram illustrating a configuration example of an information processing system 500 according to the fifth example embodiment. The information processing system 500 includes an information processing device 502 in place of the information processing device 102 according to the first example embodiment. The information processing device 502 functionally includes an estimation unit 513 in place of the estimation unit 113 according to the first example embodiment. Except for these, the information processing system 500 according to the present example embodiment may be configured similarly to the information processing device 102 according to the first example embodiment.

The estimation unit 513 has a function similar to that of the estimation unit 113 according to the first example embodiment. The estimation unit 513 functionally includes a subject estimation unit 221 similar to that of the second example embodiment and a shape estimation unit 522.

The shape estimation unit 522 estimates a shape type and a shape parameter relevant to the subject using the shape estimation model with the feature extracted by the feature extraction unit 112 as an input. The shape estimation model is a trained machine learning model for estimating a rough shape of a subject shown in an image. Types of a plurality of shapes may be determined in advance as the shape type estimated by the shape estimation model. A processing target image may be further input to the shape estimation model.

At the time of training the shape estimation model, supervised learning for estimating the shape type and the shape parameter relevant to the subject included in the training images may be performed using the feature extracted from the training images. At the time of training the shape estimation model, a training images may be further input.

In this training, for example, training for estimating the shape type and the shape parameter may be performed so that the above-described matching score is maximized. That is, the shape estimation model may be a machine learning model that has trained to output a shape type and a shape parameter indicating the rough shape of the subject such that a matching score indicating the degree of matching of the shape to the outer edge of the subject becomes high with the feature of the subject included in the training images as an input.

The functional configuration example of the information processing system 500 according to the fifth example embodiment has been mainly described above. The information processing system 500 may be physically configured similarly to the information processing system 100 according to the first example embodiment. From here, an operation example of the information processing system 500 according to the fifth example embodiment will be described.

### Operation Example of Information Processing System 500 According to Fifth Example Embodiment

Similarly to the information processing device 102 according to the first example embodiment, the information processing device 502 executes information processing for recognizing the rough shape of the subject included in the processing target image.

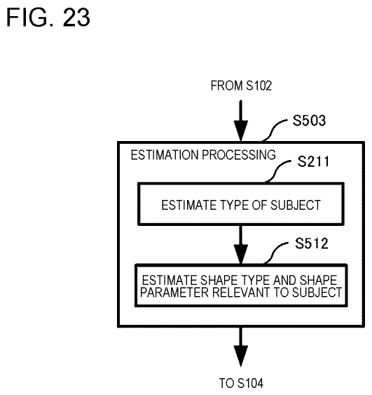

FIG. 23 is a flowchart illustrating an example of information processing according to the fifth example embodiment. The information processing according to the fifth example embodiment includes estimation processing (step S503) in place of the estimation processing (step S103) according to the first example embodiment. Except for this, the information processing according to the second example embodiment may be similar to the information processing according to the first example embodiment. FIG. 23 illustrates details of the estimation processing (step S503).

Similarly to step S103 according to the first example embodiment, the estimation unit 513 estimates the type of the subject, and the shape type and the shape parameter relevant to the subject using the feature extracted in step S102 (step S503).

As illustrated in the drawing, the subject estimation unit 221 executes step S211 similar to that of the second example embodiment.

The shape estimation unit 522 estimates a shape type and a shape parameter relevant to the subject using the shape estimation model using the feature extracted in step S102 (step S512). Subsequently, step S104 similar to that in the first example embodiment is executed.

### Operation and Effect

As described above, according to the present example embodiment, the shape estimation unit 522 estimates the shape type and the shape parameter relevant to the subject using the trained shape estimation model that has performed training for estimating the rough shape of the subject shown in the image with the extracted feature as an input.

As a result, the rough shape of the subject in the processing target image can be estimated using any of various shapes included in the shape type. Therefore, it is possible to recognize a rough shape that favorably approximates the outer edge of the subject included in the image.

According to the present example embodiment, the shape estimation model is a machine learning model that has performed training for outputting a shape type and a shape parameter indicating a rough shape of a subject so as to increase a matching score, with a feature of the subject included in a training images as an input. The matching score indicates the degree to which the shape is matched with the outer edge of the subject.

As a result, it is possible to estimate the rough shape of the subject in the processing target image using a shape that is highly matched with the outer edge of the subject. Therefore, it is possible to recognize a rough shape that favorably approximates the outer edge of the subject included in the image.

### Sixth Example Embodiment

The estimation result regarding the rough shape of the subject described in other example embodiments may be used for recognition. For example, it is possible to extract a predetermined subject region such as a face or an iris of a person or the like included in the processing target image using the estimation result and perform biometric recognition such as face recognition or iris recognition. In the sixth example embodiment, a case where the subject is a face (head) or an iris will be described as an example. Such subjects are typically part of a person, but may also be part of an animal, such as a dog, a snake, etc.

In the present example embodiment, in order to simplify the description, points different from the first example embodiment will be mainly described, and the description overlapping with the first example embodiment will be appropriately omitted.

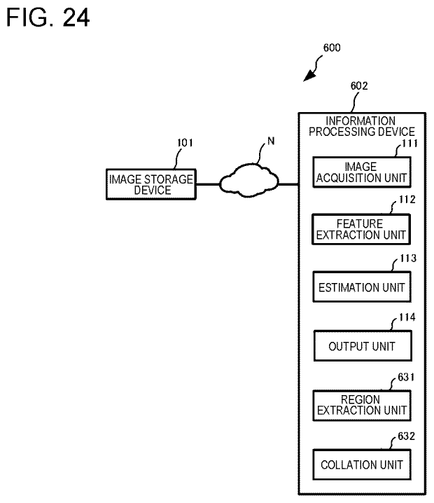

FIG. 24 is a diagram illustrating a configuration example of an information processing system 600 according to the sixth example embodiment. The information processing system 600 includes an information processing device 602 in place of the information processing device 102 according to the first example embodiment. The information processing device 602 functionally includes a region extraction unit 631 and a collation unit 632 in addition to the configuration included in the information processing device 102 according to the first example embodiment. Except for these, the information processing system 200 according to the present example embodiment may be configured similarly to the information processing device 102 according to the first example embodiment.

The region extraction unit 631 extracts a subject region, which is an image region in which a subject appears, from the processing target image based on the shape type and the shape parameter estimated by the estimation unit 113.

The subject according to the present example embodiment is, for example, a face (head) or an iris. For example, in a case where the subject is the iris, the shape type may include a double circle, a shape in which a part of the upper and lower sides of the double circle is cut out, and the like.

The collation unit 632 performs collation processing for recognition by using the extracted subject region. The recognition is, for example, biometric recognition. Specifically, for example, the recognition is face recognition in a case where the subject is a face. The recognition is iris recognition in a case where the subject is an iris. A general technique may be used for the collation processing for such recognition.

The functional configuration example of the information processing system 600 according to the sixth example embodiment has been mainly described above. The information processing system 600 may be physically configured similarly to the information processing system 100 according to the first example embodiment. From here, an operation example of the information processing system 600 according to the sixth example embodiment will be described.

### Operation Example of Information Processing System 600 According to Sixth Example Embodiment

The information processing device 602 executes information processing. The information processing according to the present example embodiment includes recognition processing in addition to the information processing executed by the information processing device 102 according to the first example embodiment. The recognition processing is processing for recognizing a person or the like registered in advance based on the processing target image.

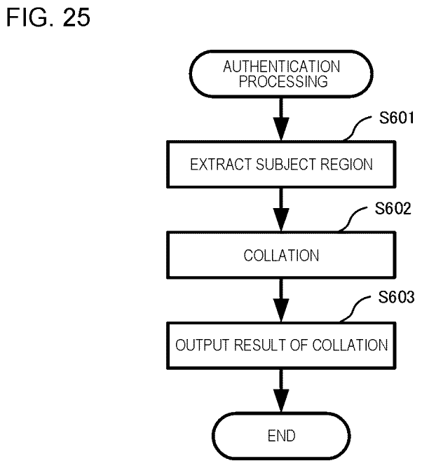

FIG. 25 is a flowchart illustrating an example of the recognition processing according to the sixth example embodiment.

The region extraction unit 631 extracts a subject region, which is an image region in which a subject appears, from the processing target image based on, for example, the shape type and the shape parameter output in step S104 (step S601).

The collation unit 632 performs collation processing for recognition by using the subject region extracted in step S601 (step S602).

Specifically, for example, the collation unit 632 holds registration information including a feature of a person registered in advance. The collation unit 632 extracts the feature of the subject region extracted in step S601. The collation unit 632 collates the extracted feature with the feature included in the registration information. The collation unit 632 generates, for example, collation result information indicating whether the degree of similarity of the collated features is equal to or more than a predetermined threshold as a result of the collation. The collation processing described here is an example, and the collation processing is not limited thereto.

The collation unit 632 outputs a result of the collation performed in Step S602 (Step S603). This output may be an indication or a transmission to another device (not illustrated).

According to this recognition processing, the subject region can be extracted using the shape type and the shape parameter estimated in step S103. Therefore, for example, by including a shape relevant to a face shape, an iris shape, or the like in various states in the shape type, the subject region can be accurately and easily extracted. Therefore, collation can be performed with high accuracy.

The various states are, for example, a state in which a plurality of persons are included in the subject image and the faces of the plurality of persons overlap each other in a case where the subject is a face. Examples of the various states include a blinking state and a state in which the eye is opened in a case where the subject is the iris.

### Operation and Effect

As described above, according to the present example embodiment, the information processing system 600 further includes the region extraction unit 631 and the collation unit 632. The region extraction unit 631 extracts a subject region, which is an image region in which a subject appears, from the image based on the estimated shape type and shape parameters. The collation unit 632 performs collation processing for recognition by using the extracted subject region. The subject is a face or an iris.

As a result, as described above, the subject region can be accurately and easily extracted. Therefore, collation can be performed with high accuracy.

According to the present example embodiment, the image includes a plurality of persons whose faces overlap each other.

Even in such an image, as described above, it is possible to accurately and easily extract the face region that is the subject region. Therefore, collation for face recognition can be accurately performed.

### First Modification

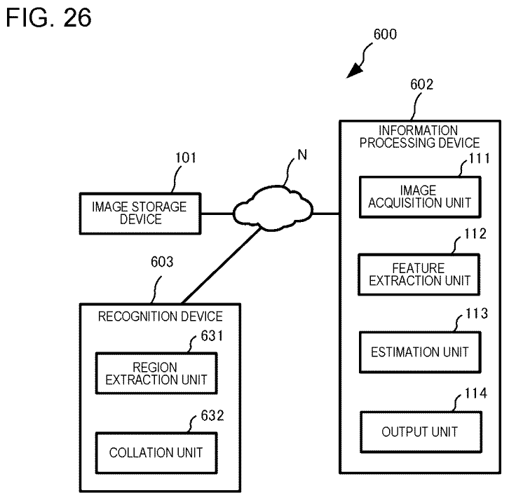

FIG. 26 is a diagram illustrating a configuration example of an information processing system 600 according to a first modification. The information processing system 600 according to the first modification includes an recognition device 603 in addition to the image storage device 101 and the information processing device 102 similar to those of the first example embodiment. The recognition device 603 includes a region extraction unit 631 and a collation unit 632 similar to those in the sixth example embodiment.

That is, in the present modification, the recognition device 603 different from the information processing device 102 has a function of executing the recognition processing. This configuration also achieves effects similar to those of the sixth example embodiment.

Although the example embodiments and modifications of the present invention have been described above with reference to the drawings, these are examples of the present invention, and various configurations other than the above can be adopted.

In the plurality of flowcharts used in the above description, a plurality of steps (processing) is described in order, but the execution order of the steps executed in each of the example embodiments is not limited to the described order. In each of the example embodiments, the order of the illustrated steps can be changed as long as there is no problem in terms of content. The above-described example embodiments and modifications can be combined within a range in which the contents are not contradictory.

Some or all of the above example embodiments may be described as the following supplementary notes, but are not limited to the following.
1. An information processing system including:
a feature extraction means for extracting a feature of a subject shown in an image; and
an estimation means for estimating a type of the subject, and a shape type and a shape parameter relevant to the subject using the extracted feature.
2. The information processing system according to 1, in which
the estimation means includes:
a subject estimation means for estimating a type of the subject using the extracted feature; and
a shape estimation means for estimating the shape type and the shape parameter relevant to the subject based on the estimated type of the subject or the extracted feature.
3. The information processing system according to 2, in which
the shape estimation means includes:
a shape type estimation means for estimating the one or more shape types relevant to the subject based on the estimated type of the subject or the extracted feature; and
a parameter estimation means for estimating the shape parameter relevant to the subject for the one or more estimated shape types.
4. The information processing system according to 3, in which
the shape type estimation means estimates the one or more shape types relevant to the subject based on the estimated type of the subject and association information associated with the type of the subject and the one or more shape types.
5. The information processing system according to 3, in which
the shape type estimation means estimates the one or more shape types relevant to the subject by using a trained shape type estimation model that has performed training for estimating at least one shape type relevant to the subject shown in the image with the extracted feature as an input.
6. The information processing system according to any one of 3 to 5, in which
the parameter estimation means includes:
first to Nth shape-type-specific estimation means for estimating the shape parameter relevant to the subject for a shape type associated with each of predetermined first to Nth shape types; and
a selection means for selecting, based on the estimated one or more shape types, a shape-type-specific estimation means used to estimate the shape parameter relevant to the subject.
7. The information processing system according to any one of 3 to 6, in which
the shape estimation means further includes a determination means for, in a case where there are a plurality of the estimated shape types, determining the shape type and the shape parameter relevant to the subject based on a shape parameter estimated for each of the plurality of shape types and a matching score indicating an extent to which the shape is matched with an outer edge of the subject.
8. The information processing system according to 2, in which
the shape estimation means estimates the shape type and the shape parameter relevant to the subject by using a trained shape estimation model that has performed training for estimating a rough shape of the subject shown in the image with the extracted feature as an input.
9. The information processing system according to 8, in which
the shape estimation model is a trained machine learning model that has performed training for outputting the shape type and the shape parameter indicating a rough shape of the subject in such a way that a matching score indicating a degree of matching of the shape to an outer edge of the subject becomes high with a feature of the subject included in a training images as an input.
10. The information processing system according to 7 or 9, in which
the matching score is a value obtained according to a rough shape estimation criterion defined using areas of at least two regions among (A) a first region that is a region in which a shape and a subject overlap each other, (B) a second region that is a region within a subject protruding from the shape, and (C) a third region that is a region within a shape protruding from the subject.
11. The information processing system according to any one of 1 to 10, in which
the shape type includes at least one of a polygon, a circle, an ellipse, a curve, a closed curve, and a straight line, and
the shape parameter includes at least one of a size and a rotation angle of a shape indicated by the shape type, and a position in the image.
12. The information processing system according to 11, in which
the shape parameter is represented by a fixed-length vector common to the shape types.
13. The information processing system according to any one of 1 to 12, further including:
a region extraction means for extracting a subject region, which is an image region in which the subject appears, from the image based on the estimated shape type and shape parameters; and
a collation means for performing collation processing for recognition using the extracted subject region,
in which the subject is a face or an iris.
14. The information processing system according to 13, in which
the image includes a plurality of persons whose faces overlap each other.
15. The information processing system according to any one of 1 to 14, further including:
an image storage device that stores the image.
16. An information processing device including:
a feature extraction means for extracting a feature of a subject shown in an image; and
an estimation means for estimating a type of the subject, and a shape type and a shape parameter relevant to the subject using the extracted feature.
17. An information processing method for causing at least one computer to execute:
extracting a feature of a subject shown in an image; and
estimating a type of the subject, and the shape type and the shape parameter relevant to the subject using the extracted feature.
18. The information processing method according to 17, in which
the estimating of the type of the subject and the shape type and the shape parameter relevant to the subject includes:
estimating the type of the target using the extracted feature; and
estimating the shape type and the shape parameter relevant to the subject based on the estimated type of the subject or the extracted feature.
19. The information processing method according to 18, in which
the estimating of the shape type and the shape parameter includes:
estimating one or more the shape types relevant to the subject based on the estimated type of the subject or the extracted feature; and
estimating the shape parameter relevant to the subject for the one or more estimated shape types.
20. The information processing method according to 19, in which
the estimating of the shape type includes estimating the one or more shape types relevant to the subject based on the estimated type of the subject and association information associated with the type of the subject and the one or more shape types.
21. The information processing method according to 19, in which
the estimating of the shape type includes estimating the one or more shape types relevant to the subject by using a trained shape type estimation model that has performed training for estimating at least one shape type relevant to the subject shown in the image with the extracted feature as an input.
22. The information processing method according to any one of 19 to 21, in which
the estimating of the shape parameter includes:
estimating the shape parameter relevant to the subject by using first to Nth shape-type-specific estimation means associated with predetermined first to Nth shape types; and
selecting a shape-type-specific estimation means to be used for estimating the shape parameter relevant to the subject based on the estimated one or more shape types.
23. The information processing method according to any one of 19 to 22, in which
the estimating of the shape type and the shape parameter further includes, in a case where there are a plurality of the estimated shape types, determining the shape type and the shape parameter relevant to the subject based on a shape parameter estimated for each of the plurality of shape types and a matching score indicating an extent to which the shape is matched with an outer edge of the subject.
24. The information processing method according to 18, in which
the estimating of the shape type and the shape parameter includes estimating the shape type and the shape parameter relevant to the subject by using a trained shape estimation model that has performed training for estimating a rough shape of the subject shown in the image with the extracted feature as an input.
25. The information processing method according to 24, in which
the shape estimation model is a trained machine learning model that has performed training for outputting the shape type and the shape parameter indicating a rough shape of the subject in such a way that a matching score indicating a degree of matching of the shape to an outer edge of the subject becomes high with a feature of the subject included in a training images as an input.
26. The information processing method according to 23 or 25, in which
the matching score is a value obtained according to a rough shape estimation criterion defined using areas of at least two regions among (A) a first region that is a region in which a shape and a subject overlap each other, (B) a second region that is a region within a subject protruding from the shape, and (C) a third region that is a region within a shape protruding from the subject.
27. The information processing method according to any one of 17 to 26, in which
the shape type includes at least one of a polygon, a circle, an ellipse, a curve, a closed curve, and a straight line, and
the shape parameter includes at least one of a size and a rotation angle of a shape indicated by the shape type, and a position in the image.
28. The information processing method according to 27, in which
the shape parameter is represented by a fixed-length vector common to the shape types.
29. The information processing method according to any one of 17 to 28, further including:
extracting a subject region, which is an image region in which the subject appears, from the image based on the estimated shape type and shape parameters; and
performing collation processing for recognition using the extracted subject region,
in which the subject is a face or an iris.
30. The information processing method according to 29, in which
the image includes a plurality of persons whose faces overlap each other.
31. A recording medium having recorded therein a program causing at least one computer to execute:
extracting a feature of a subject shown in an image; and
estimating a type of the subject, and the shape type and the shape parameter relevant to the subject using the extracted feature.
32. The recording medium according to 31, in which
the estimating of the type of the subject and the shape type and the shape parameter relevant to the subject includes:
estimating the type of the target using the extracted feature; and
estimating the shape type and the shape parameter relevant to the subject based on the estimated type of the subject or the extracted feature.
33. The recording medium according to 32, in which
the estimating of the shape type and the shape parameter includes:
estimating one or more the shape types relevant to the subject based on the estimated type of the subject or the extracted feature; and
estimating the shape parameter relevant to the subject for the one or more estimated shape types.
34. The recording medium according to 33, in which
the estimating of the shape type includes estimating the one or more shape types relevant to the subject based on the estimated type of the subject and association information associated with the type of the subject and the one or more shape types.
35. The recording medium according to 33, in which
the estimating of the shape type includes estimating the one or more shape types relevant to the subject by using a trained shape type estimation model that has performed training for estimating at least one shape type relevant to the subject shown in the image with the extracted feature as an input.
36. The recording medium according to any one of 33 to 35, in which
the estimating of the shape parameter includes:
estimating the shape parameter relevant to the subject by using first to Nth shape-type-specific estimation means associated with predetermined first to Nth shape types; and
selecting a shape-type-specific estimation means to be used for estimating the shape parameter relevant to the subject based on the estimated one or more shape types.
37. The recording medium according to any one of 33 to 36, in which
the estimating of the shape type and the shape parameter further includes, in a case where there are a plurality of the estimated shape types, determining the shape type and the shape parameter relevant to the subject based on a shape parameter estimated for each of the plurality of shape types and a matching score indicating an extent to which the shape is matched with an outer edge of the subject.
38. The recording medium according to 32, in which
the estimating of the shape type and the shape parameter includes estimating the shape type and the shape parameter relevant to the subject by using a trained shape estimation model that has performed training for estimating a rough shape of the subject shown in the image with the extracted feature as an input.
39. The recording medium according to 38, in which
the shape estimation model is a trained machine learning model that has performed training for outputting the shape type and the shape parameter indicating a rough shape of the subject in such a way that a matching score indicating a degree of matching of the shape to an outer edge of the subject becomes high with a feature of the subject included in a training images as an input.
40. The recording medium according to 37 or 39, in which
the matching score is a value obtained according to a rough shape estimation criterion defined using areas of at least two regions among (A) a first region that is a region in which a shape and a subject overlap each other, (B) a second region that is a region within a subject protruding from the shape, and (C) a third region that is a region within a shape protruding from the subject.
41. The recording medium according to any one of 31 to 40, in which
the shape type includes at least one of a polygon, a circle, an ellipse, a curve, a closed curve, and a straight line, and
the shape parameter includes at least one of a size and a rotation angle of a shape indicated by the shape type, and a position in the image.
42. The recording medium according to 41, in which
the shape parameter is represented by a fixed-length vector common to the shape types.
43. The recording medium according to any one of 31 to 42, further including:
extracting a subject region, which is an image region in which the subject appears, from the image based on the estimated shape type and shape parameters; and
performing collation processing for recognition using the extracted subject region,
in which the subject is a face or an iris.
44. The recording medium according to 43, in which
the image includes a plurality of persons whose faces overlap each other.

### REFERENCE SIGNS LIST

100, 200, 300, 500, 600 information processing system
101 image storage device
102, 202, 302, 502, 602 information processing device
111 image acquisition unit
112 feature extraction unit
113, 213, 313, 513 estimation unit
114 output unit
221 subject estimation unit
222, 322, 522 shape estimation unit
231 association information storage unit
231a association information
232, 332 shape type estimation unit
233 parameter estimation unit
233A shape-type-specific estimation unit
233B selection unit
234 determination unit
603 recognition device
631 region extraction unit
632 collation unit

What is claimed is:

1. An information processing system comprising:
at least one memory configured to store instructions; and
at least one processor configured to execute the instructions to:
extract a feature of a subject shown in an image; and
estimates a type of the subject, and a shape type and a shape parameter relevant to the subject using the extracted feature.

2. The information processing system according to claim 1, wherein
estimating the type of the subject includes:
estimating a type of the subject using the extracted feature; and
estimating the shape type and the shape parameter relevant to the subject based on the estimated type of the subject or the extracted feature.

3. The information processing system according to claim 2, wherein
estimating the shape type and the shape parameter includes:
estimating the one or more shape types relevant to the subject based on the estimated type of the subject or the extracted feature; and
estimating the shape parameter relevant to the subject for the one or more estimated shape types.

4. The information processing system according to claim 3, wherein
estimating the one or more shape types includes estimating the one or more shape types relevant to the subject based on the estimated type of the subject and association information associated with the type of the subject and the one or more shape types.

5. The information processing system according to claim 3, wherein
estimating the one or more shape types includes estimating the one or more shape types relevant to the subject by using a trained shape type estimation model that has performed training for estimating at least one shape type relevant to the subject shown in the image with the extracted feature as an input.

6. The information processing system according to claim 3, wherein
estimating the shape parameter includes:
estimating the shape parameter relevant to the subject for a shape type associated with each of predetermined first to Nth shape types; and
selecting, based on the estimated one or more shape types, a shape-type-specific estimation means used to estimate the shape parameter relevant to the subject.

7. The information processing system according to claim 3, wherein
estimating the shape type and the shape parameter further includes, in a case where there are a plurality of the estimated shape types, determining the shape type and the shape parameter relevant to the subject based on a shape parameter estimated for each of the plurality of shape types and a matching score indicating an extent to which the shape is matched with an outer edge of the subject.

8. The information processing system according to claim 2, wherein
estimating the shape type and the shape parameter includes estimating the shape type and the shape parameter relevant to the subject by using a trained shape estimation model that has performed training for estimating a rough shape of the subject shown in the image with the extracted feature as an input.

9. The information processing system according to claim 8, wherein
the shape estimation model is a trained machine learning model that has performed training for outputting the shape type and the shape parameter indicating a rough shape of the subject in such a way that a matching score indicating a degree of matching of the shape to an outer edge of the subject becomes high with a feature of the subject included in a training images as an input.

10. The information processing system according to claim 7, wherein
the matching score is a value obtained according to a rough shape estimation criterion defined using areas of at least two regions among (A) a first region that is a region in which a shape and a subject overlap each other, (B) a second region that is a region within a subject protruding from the shape, and (C) a third region that is a region within a shape protruding from the subject.

11. The information processing system according to claim 1, wherein
the shape type includes at least one of a polygon, a circle, an ellipse, a curve, a closed curve, and a straight line, and
the shape parameter includes at least one of a size and a rotation angle of a shape indicated by the shape type, and a position in the image.

12. The information processing system according to claim 11, wherein
the shape parameter is represented by a fixed-length vector common to the shape types.

13. The information processing system according to claim 1,
the at least one processor configured to execute the instructions to:
extract a subject region, which is an image region in which the subject appears, from the image based on the estimated shape type and shape parameters; and
perform collation processing for recognition using the extracted subject region,
wherein the subject is a face or an iris.

14. The information processing system according to claim 13, wherein
the image includes a plurality of persons whose faces overlap each other.

15. (canceled)

16. An information processing method for causing at least one computer to execute:
extracting a feature of a subject shown in an image; and
estimating a type of the subject, and the shape type and the shape parameter relevant to the subject using the extracted feature.

17. A non-transitory computer readable medium having recorded therein a program causing at least one computer to execute:
extracting a feature of a subject shown in an image; and
estimating a type of the subject, and the shape type and the shape parameter relevant to the subject using the extracted feature.
